(19) United States
(12) Patent Application Publication
(10) Pub. No.: US 2007/0103090 A1
(43) Pub. Date: May 10, 2007

(54) Piezoelectric ignition circuit for lighting fixtures

(75) Inventors: Ying-Nan Cheng, Taipei Hsien (TW); Ying-Chang Cheng, Taipei Hsien (TW); Chin-Biau Chung, Taipei Hsien (TW)

Correspondence Address: BIRCH STEWART KOLASCH & BIRCH, PO BOX 747, FALLS CHURCH, VA, 22040-0747, US

(73) Assignee: Zippy Technology Corp.

(21) Appl. No.: 11/268,506

(22) Filed: Nov. 8, 2005

(51) Int. Cl. F02P 3/12

(52) U.S. Cl. 315/209 PZ

(57) ABSTRACT

A piezoelectric ignition circuit for lighting fixtures adopted for use on lighting fixtures such as fluorescent lamps, lighting bulbs, neon lights and the like to replace the winding coil transformer and electronic stabilizer used in the conventional lighting fixtures to overcome the occurred shortcomings such as a shorter life span, bulky size, higher cost and temperature, and lower luminance. The invention employs a piezoelectric transformer which can rapidly boost voltage to achieve benefits of a longer life span, smaller size, lower cost and temperature, and greater luminance.

### FIELD OF THE INVENTION

The present invention relates to a piezoelectric ignition circuit for indoor and outdoor lighting fixtures such as fluorescent lamps, lighting bulbs, neon lights and the like and particularly to an ignition circuit that employs the characteristic of high voltage boosting ratio of the piezoelectric transformer to increase the life span, reduce the size, lower the cost and temperature and enhance the luminance of lighting fixtures.

### BACKGROUND OF THE INVENTION

The conventional ignition circuits for indoor and outdoor lighting fixtures such as fluorescent lamps, lighting bulbs, neon lights and the like mostly adopt winding coil transformers and electronic stabilizers. Due to size constraint, the coil number of the winding coil transformers is limited. Moreover, such ignition circuits generally do not include a power factor corrector and the luminance of the lighting fixtures also is constrained. To achieve a greater luminance, the size of the lighting fixtures must be increased to have more space to accommodate the winding coil transformer. Such an approach results in a greater power and higher temperature of the lighting fixtures, their life span suffers. Moreover, the bigger lighting fixtures do not fit in many environments (such as closed wall lamps or ceiling lamps). The fitting lighting fixtures cannot provide sufficient luminance. As a result, the lighting bulbs cannot be used universally on indoor and outdoor lighting fixtures.

### SUMMARY OF THE INVENTION

The primary object of the present invention is to solve the aforesaid disadvantages. The invention aims to be used on indoor and outdoor lighting fixtures such as fluorescent lamps, lighting bulbs, neon lights and the like. It mainly replaces the winding coil transformer and electronic stabilizer used in the conventional lighting fixtures to overcome the occurred shortcomings such as shorter life span, bulky size, higher cost and temperature and lower luminance. The present invention employs a piezoelectric transformer that can boost voltage rapidly, thereby can increase the life span, shrink the size, reduce the cost, lower the temperature and enhance the luminance.

The foregoing, as well as additional objects, features and advantages of the invention will be more readily apparent from the following detailed description, which proceeds with reference to the accompanying drawings.

### BRIEF DESCRIPTION OF THE DRAWINGS

FIGS. 1 and 2 are circuit block diagrams of an embodiment of the present invention.

### DETAILED DESCRIPTION OF THE PREFERRED EMBODIMENTS

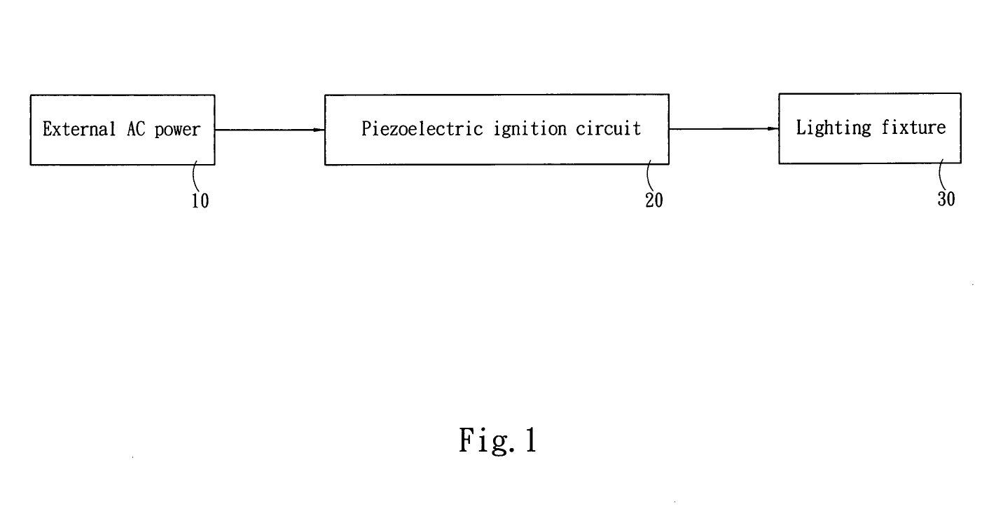

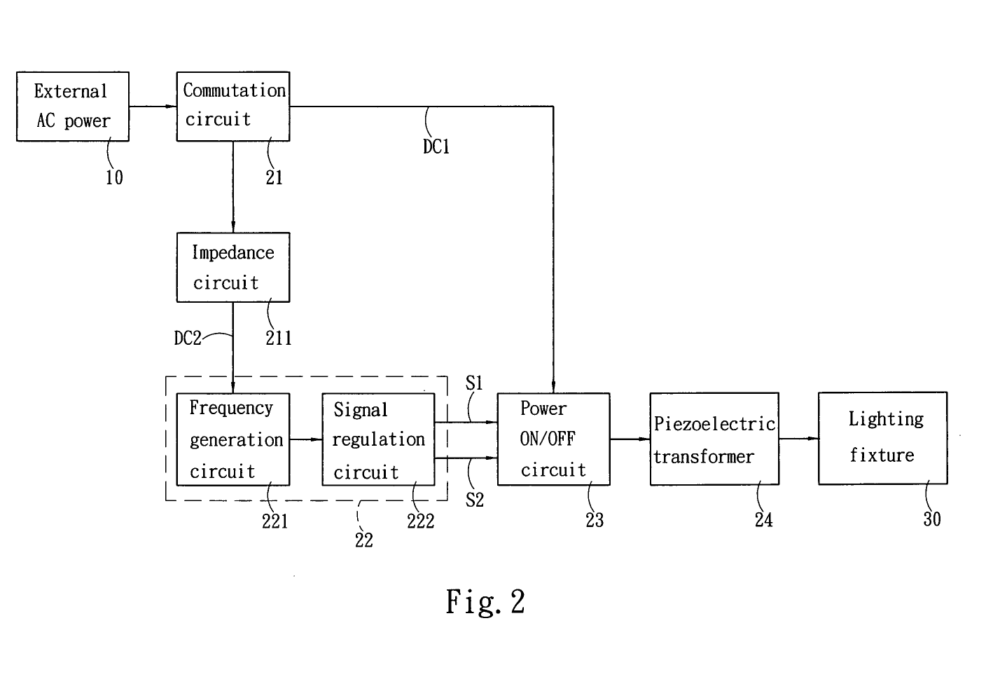

Please refer to FIGS. 1 and 2 for the circuit block diagrams of an embodiment of the invention. The invention includes a piezoelectric ignition circuit 20 adopted for use on a lighting fixture 30. It includes a piezoelectric transformer 24 as a power source of a transformed-voltage power to drive the lighting fixture 30 at a rear end. The piezoelectric ignition circuit 20 mainly includes a commutation circuit 21 which receives and transforms an external AC power 10 and outputs DC power. The piezoelectric ignition circuit 20 is located and integrated in the lighting fixture 30 to receive and transform the AC power. The DC power is divided into a high voltage DC power DC1 and a lower voltage DC power DC2 generated by flowing through an impedance circuit 211 to be used by a driving IC 22. The driving IC 22 is driven by the lower DC power DC2. The driving IC 22 includes a frequency generation circuit 221 which is corresponding to a resonant frequency of the piezoelectric transformer 24 and outputs ON/OFF signals, and a signal regulation circuit 222 which receives the ON/OFF signals to provide signal level regulation to output a high level signal SI and a low level signal S2. The frequency generation circuit 221 is a RC frequency generation circuit to output a pulse-width modulation signal. The signal regulation circuit 222 may be a TOTEM POLE phase regulation circuit to output the high level signal SI and the low level signal S2 that are in a floating level mode and have a delay time difference. The signal is generated to drive a power ON/OFF circuit 23 at the rear end. The power ON/OFF circuit 23 is a power MOSFET. The power ON/OFF circuit 23 is driven alternately by the delay time difference of the high level signal S1 and the lower level signal S2 to determine the ON/OFF time sequence of the high voltage power DC1 entering the piezoelectric transformer 24. The piezoelectric transformer 24 receives the high voltage DC power DC1 and transforms to a required higher voltage power according to the oscillation frequency for the lighting fixture 30 at the rear end.

The invention provides a complete installable circuit. The conventional electronic stabilizer and winding coil transformer are replaced by the driving IC 22, power ON/OFF circuit 23 and piezoelectric transformer 24. The size is smaller and the fabrication cost is lower. The piezoelectric transformer 24 has a higher voltage boosting ratio and lower temperature. Thus the lighting fixture 30 adopted the piezoelectric ignition circuit 20 of the invention can maintain the rated life span. Moreover, the lighting fixture 30 may also be a gas discharge lamp to generate a greater luminance when driven by the high voltage of the piezoelectric ignition circuit 20 at the same size.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A piezoelectric ignition circuit for lighting fixtures using a piezoelectric transformer as a power source of a transformed-voltage power to drive a lighting fixture at a rear end, comprising:
a commutation circuit which receives and transforms an external AC power and outputs DC power which is divided to become a low voltage DC power by flowing through an impedance circuit and a high voltage DC power;
a driving IC which is driven by the low voltage DC power and includes a frequency generation circuit corresponding to a resonant frequency of the piezoelectric transformer to output ON/OFF signals, and a signal regulation circuit which receives the ON/OFF signals to provide signal level regulation to output a high level signal and a low level signal;
a power ON/OFF circuit driven alternately by the high level signal and the low level signal to determine ON/OFF time sequence of the high voltage DC power entering the piezoelectric transformer; and
a piezoelectric transformer to receive the high voltage DC power and, boost the voltage to drive the lighting feature at the rear end.

2. The piezoelectric ignition circuit of claim 1, wherein the frequency generation circuit is a RC frequency generation circuit.

3. The piezoelectric ignition circuit of claim 1, wherein the signal regulation circuit is a TOTEM POLE phase regulation circuit.

4. The piezoelectric ignition circuit of claim 1, wherein the power ON/OFF circuit is a power MOSFET.
